(19) United States
(12) Patent Application Publication
(10) Pub. No.: US 2024/0012116 A1
(43) Pub. Date: Jan. 11, 2024

(54) LIDAR DEVICE FOR A VEHICLE AND METHOD FOR OPTICALLY DETECTING A FIELD OF VIEW FOR A VEHICLE

(71) Applicant: Robert Bosch GmbH, Stuttgart (DE)

(72) Inventor: Klaus Stoppel, Mundelsheim (DE)

(21) Appl. No.: 18/333,307

(22) Filed: Jun. 12, 2023

(30) Foreign Application Priority Data
Jun. 15, 2022 (DE) 10 2022 206 076.8

(51) Int. Cl. G01S 7/481; G02B 5/09; G02B 7/182; G01S 17/931; G01S 7/484

(52) U.S. Cl. CPC G01S 7/4817; G02B 5/09; G02B 7/1821; G01S 17/931; G01S 7/484

(57) ABSTRACT

A LIDAR device for a vehicle. The LIDAR device includes: an emitter for emitting at least one laser beam on an emission path, a receiver for receiving at least one reflected laser beam on a receiving path, and a rotating mirror for deflecting the laser beam via the emission path into the field of view and for deflecting the laser beam reflected in the field of view onto the receiving path. The rotating mirror is situated between the emitter and the receiver and separates the emission path from the receiving path. The rotating mirror is a polygon mirror and includes at least one mirror surface. The laser beam emitted via the emission path into the field of view and the laser beam reflected from the field of view strike the same at least one mirror surface of the polygon mirror essentially in the same plane.

### FIELD

The present invention relates to a LIDAR device for a vehicle. In addition, the present invention relates to a method for optically detecting a field of view for a vehicle.

### BACKGROUND INFORMATION

A LIDAR device including an emitter and a receiver and a rotating mirror is described in Korea Patent Application No. KR 10 2013 165 B1, the emitter and receiver being situated at opposite sides of a rotating mirror.

### SUMMARY

An object of the present invention is to provide an improved LIDAR device and an optimized method for detecting a field of view.

This object may be achieved by the features of the present invention. Advantageous specific example embodiments of the present invention are disclosed herein.

A LIDAR device for a vehicle is provided. According to an example embodiment of the present invention, the LIDAR device includes an emitter for emitting at least one laser beam on an emission path and a receiver for receiving at least one reflected laser beam on a receiving path. The LIDAR device further includes a rotating mirror for deflecting the laser beam via the emission path into the field of view and for deflecting the laser beam reflected in the field of view onto the receiving path. The rotating mirror is situated between the emitter and the receiver and separates the emission path from the receiving path. The rotating mirror is designed as a polygon mirror and includes at least one mirror surface for deflecting the laser beam via the emission path into the field of view and for deflecting the laser beam reflected in the field of view onto the receiving path. The laser beam emitted via the emission path into the field of view and the laser beam reflected from the field of view strike the same at least one mirror surface of the polygon mirror essentially in the same plane.

In conventional LIDAR devices, emitter and receiver are frequently positioned on top of one another, so that the rotating mirror must be dimensioned sufficiently large enough with respect to its height so that the laser beam emitted by the emitter into the field of view and the laser beam reflected in the field of view are each able to strike the rotating mirror. The provided LIDAR device advantageously allows for a preferably flat design of the LIDAR device or of the LIDAR sensor as a result of the arrangement of emitter, receiver and polygon mirror in the form of a rotating mirror. Due, in particular, to the characteristic and arrangement of the laser beams via the emission path into the field of view and via the field of view into the receiving path, each of which are located essentially at the same height, and given the fact that the aforementioned laser beams strike the same at least one mirror surface of the polygon mirror essentially at the same height, i.e., essentially in the same plane, the LIDAR device as a whole may have a flat design, since the height of the rotating mirror of the polygon mirror is reduced due to the provided arrangement of the components of the device.

The flat design or shape of the provided LIDAR device advantageously enables a use of the device in installation locations in the vehicle at which very little space is available, for example, in the vehicle roof or at the radiator grill.

In addition, the provided LIDAR device according to an example embodiment of the present invention may yield the advantage of reducing potential receiver interferences resulting from emission beam reflections (an emission beam corresponding to the aforementioned laser beam emitted into the field of view) as a result of optical crosstalk from the emission path to the receiving path. The spatial or local separation of the emission path and of the receiving path thus improves the quality of the received signal (i.e., of the laser beam reflected in the field of view), in particular, in close range.

A further advantage of the spatial or local separation of emitter and receiver is that the heat dissipation of the aforementioned components may thus be more efficiently designed. A more efficient heat dissipation also affects the electro-optical efficiency and the optical performance of the LIDAR device or of the LIDAR sensor.

Alternatively, it is also possible to use in each case different polygon mirror surfaces or polygon mirror facets for the emitted and reflected laser beam.

In one further specific embodiment of the present invention, a first deflection mirror is situated in the emission path between the emitter and the polygon mirror, which enables an essentially right-angled deflection of the laser beam emitted by the emitter on the emission path onto the at least one mirror surface of the polygon mirror. In addition or alternatively, a second deflection mirror is situated in the receiving path between the polygon mirror and the receiver, the second deflection mirror enabling an essentially right-angled deflection of the laser beam reflected onto the polygon mirror on the receiving path to the receiver.

This arrangement advantageously allows for a LIDAR device narrow in the transverse direction, i.e., for example, in the horizontal direction, since the two deflection mirrors enable/allow a shift or extension of the emitter and receiver in the longitudinal direction. If the longitudinal direction corresponds, for example, to the depth plane of the device, then the depth of the device is increased accordingly.

In one further specific example embodiment of the present invention, the emitter has a planar design and is integratable into a bottom plate of the LIDAR device. In addition or alternatively, the receiver has a planar design and is integratable into a bottom plate of the LIDAR device. This design yields the advantage, provided the emitter is integrated directly into the bottom plate of the LIDAR device, that the heat dissipation (cooling) of the emitter is able to take place via the bottom plate of the LIDAR sensor. Furthermore, the possible installation space for the emitter may be enlarged due to the planar, i.e., flat design of the emitter, i.e., with minimal extension in a vertical direction or along a vertical axis of the device. The emitter may, for example, include at least one driver board with at least two emission modules, the at least two emission modules each being able to include laser elements. For example, when greater installation space is available for the emitter, further emission modules including more laser elements may be used, or the number of laser elements may be increased and an integration into the LIDAR device may take place.

In one further specific embodiment of the present invention, the emitter is situated essentially in the longitudinal direction and/or the receiver is situated essentially in the longitudinal direction. This arrangement, in combination with one deflection mirror each for the emission path and the receiving path, allows for a LIDAR device narrow in the transverse direction i.e., for example, in the horizontal direction, since the two deflection mirrors with the arrangement of emitter and receiver enable/allow a shift or extension of the emitter and receiver in the longitudinal direction.

In one further specific embodiment of the present invention, the emitter includes a first emission module and a second emission module for emitting multiple laser beams into the field of view. Situated in a first emission path between the first emission module and the polygon mirror is the first deflection mirror, which enables an essentially right-angled deflection of the laser beam emitted by the first emission module on the first emission path onto the at least one mirror surface of the polygon mirror. Situated between the second emission module and the polygon mirror in a second emission path is a third deflection mirror, which enables an essentially right-angled deflection of the laser beam emitted by the second emission module on the second emission path onto the at least one mirror surface of the polygon mirror. The laser beam emitted on the first emission path and/or the laser beam emitted on the second emission path and/or the laser beams reflected in the field of view strike the same at least one mirror surface of the polygon mirror essentially in the same plane. This arrangement utilizes the aforementioned resulting free installation space for the emitter, for example, advantageously for the use of a first and second emission module. The first and second emission module may, for example, each be situated in the longitudinal direction as described above and emit the laser beams. Moreover, it is possible that the first emission module and the second emission module each have a planar, i.e., flat, design and are integrated into the bottom plate of the device and emit laser beams. In one further alternative, it is possible that the first emission module has a, for example, planar design. With the first deflection mirror, it is then possible for the laser beam emitted by the planar first emission module on the first emission path to be deflected onto the at least one mirror facet of the polygon mirror. Moreover, the second emission module may be situated, for example, in the longitudinal direction and may emit laser radiation via a second emission path with the aid of a further deflection mirror. The emission modules may include, for example, laser elements as described above. This also applies to the remaining specific embodiments, here too, the emitter may include in each case laser elements for generating and emitting a laser beam. The design enables a flexible use of the LIDAR device and a simple adaptation to the different installation locations in a vehicle.

Alternatively or in addition to the above-described specific embodiment, according to an example embodiment of the present invention, the receiver may include a first receiving module and a second receiving module for receiving multiple laser beams from the field of view. The second deflection mirror is situated in a first receiving path between the polygon mirror and the first receiving module. The second deflection mirror enables an essentially right-angled deflection of the laser beam reflected from the field of view onto the polygon mirror on the first receiving path onto the first receiving module. A fourth deflection mirror is situated in a second receiving path between the polygon mirror and the second receiving module. The fourth deflection mirror enables an essentially right-angled deflection of the laser beam reflected from the field of view onto the polygon mirror on the second receiving path onto the second receiving module.

According to an example embodiment of the present invention, the receiving modules may, for example, include detectors such as cameras, photodiodes etc., for detecting the reflected laser beams. This applies equally to the above-described specific embodiments, in which the receiver may also include detectors, cameras, photodiodes, etc., for detecting reflected laser beams.

The provided specific embodiment, in combination with the specific embodiment, in which the two sensor modules are used, may result in a very flexibly designable and usable LIDAR device in a vehicle and may also provide freed installation space for the receiver and may take advantage of this installation space by using at least two receiving modules.

In one further specific example embodiment of the present invention, the laser beam emitted via the polygon mirror into the field of view causes a point illumination and/or a line illumination of the field of view. For all aforementioned specific embodiments, the laser beam may correspond to a light pulse, which is generated and emitted, for example, by one or by multiple laser elements. The provided device is thus flexibly adaptable to the surroundings to be scanned or to the field of view to be examined.

In one further specific example embodiment of the present invention, the polygon mirror includes four mirror surfaces. The polygon mirror is designed as a 4-fold mirror and, in combination with the arrangement of emitter, receiver and, optionally, one or multiple deflection mirrors, allows for a reduction in the mirror size and thus for an overall compact shape of the LIDAR device. The polygon mirror enables, in particular, a spatial or local separation of emission beam and reception beam and thus an improved quality of the received signal.

In one further specific example embodiment of the present invention, the polygon mirror includes a rotation drive unit for moving the polygon mirror. With the aid of the rotation drive unit, it is possible to advantageously rotate the at least one mirror surface or mirror facet of the polygon mirror, so that the emitted laser beam and the laser beam reflected from the field of view strike the same at least one mirror surface essentially in the same plane.

In one further specific embodiment of the present invention, the polygon mirror is mounted on one side or on two sides. The mounting of the mirror may be flexibly adapted to the respective installation location of the LIDAR device and enables a stable and reliable operation of the device.

A method for optically detecting a field of view for a vehicle is also provided. According to an example embodiment of the present invention, the method includes the following steps:

a) providing a LIDAR device as described above according to the present invention, and

b) detecting the field of view with the aid of the LIDAR device. The provided method enables an approach that is particularly simple and less susceptible to interference for detecting the field of view for a vehicle based on the provided LIDAR device. The susceptibility in this case is reduced, in particular, by the use and arrangement of the polygon mirror, which separates the emitter and the receiver spatially from one another. In this way, the emitted laser radiation may cause parasitic losses and reflections at the passage at the front pane of the LIDAR device or of the LIDAR sensor or in the emission optics, which may have a disruptive effect on the receiver. Due to the spatial separation of emitter and receiver, however, the emission radiation (emitted laser radiation) is no longer able to enter directly into the receiving path, which improves the quality of the received signal.

The advantageous designs and refinements of the present invention explained above and/or below may be used individually but also in arbitrary combination with one another, except, for example, in cases of unambiguous dependencies or incompatible alternatives.

The above-described properties, features and advantages of the present invention, as well as the manner in which these are achieved are more clearly and explicitly understandable in connection with the following description of exemplary embodiments, which are explained in greater detail in connection with the figures.

### BRIEF DESCRIPTION OF THE DRAWINGS

FIG. 1 schematically shows a representation of a LIDAR device according to a first specific embodiment of the present invention.

FIG. 2 schematically shows a representation of a LIDAR device according to a second specific embodiment of the present invention.

FIG. 3 schematically shows a representation of a LIDAR device according to a third specific embodiment of the present invention.

FIG. 4 schematically shows a representation of a LIDAR device according to a fourth specific embodiment of the present invention.

FIG. 5 schematically shows a representation of a method for optically detecting a field of view for a vehicle, according to an example embodiment of the present invention.

### DETAILED DESCRIPTION OF EXAMPLE EMBODIMENTS

It is noted that the figures are merely schematic in nature and are not true to scale. In this sense, components and elements shown in the figures may be depicted as excessively large or reduced for better understanding. It is further noted that the reference numerals in the figures have been chosen to be unchanged when identically designed elements and/or components are involved.

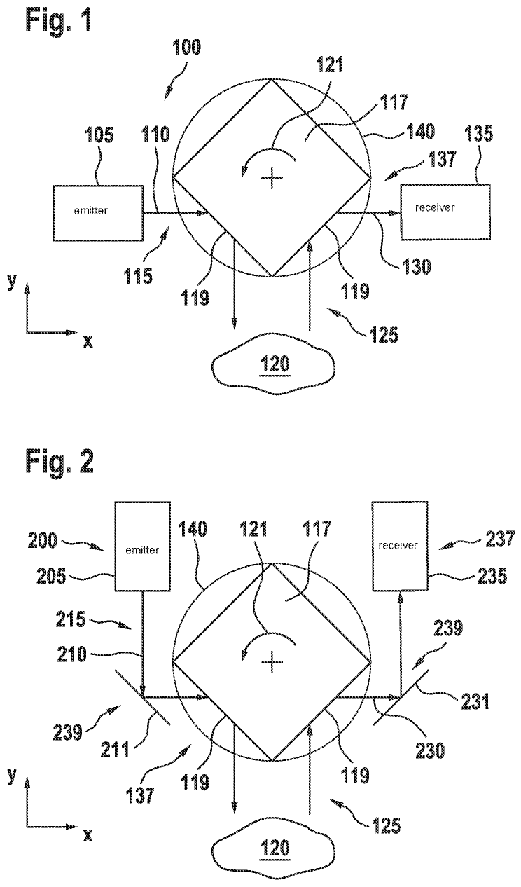

FIG. 1 schematically shows a representation of a LIDAR device 100 or of a LIDAR sensor (Automotive LIDAR, in particular, Long-Range LIDAR (LRL)) according to a first specific embodiment, the delineation of a housing completing device 100 being omitted for the sake of clarity, device 100 nonetheless being capable of including a housing or of being installed in a housing. LIDAR device 100 includes an emitter 105. Emitter 105 may, for example, include a driver board and multiple emission modules, the multiple emission modules being capable of including, for example, a plurality of laser elements for generating multiple laser beams. Emitter 105 may further include emission optics including further optical components, the aforementioned features not being delineated in FIG. 1 for the sake of clarity. Emitter 105 is situated in FIG. 1, for example, in the transverse direction, i.e., for example, horizontally or in parallel to the x-axis as schematically indicated in FIG. 1, and emits a laser beam 115 (or multiple laser beams) onto an emission path 110. Emitted laser beam 115 strikes a rotating mirror, which deflects laser beam 115 into field of view 120. The rotating mirror is designed as a polygon mirror 117 and includes four mirror facets. It is alternatively possible to use a polygon mirror that includes a different number of facets.

Laser beam 125 reflected in field of view 120 strikes polygon mirror 117, namely caused by rotation 121 of polygon mirror 117—between the emission and the reflection of the laser beam—on the same mirror facet 119 as it was also struck by laser beam 115 emitted into field of view 120. Rotation 121 of polygon mirror 117 may be implemented, for example, with the aid of a rotation drive unit 140. Rotation drive unit 140 in this case may, for example, be integrated into polygon mirror 117. Alternatively, rotation drive unit 140 may, for example, be mounted below polygon mirror 117, for example, in a bottom area of polygon mirror 117, so that polygon mirror 117 is seated on rotation drive unit 140.

LIDAR device 100 further includes a receiver 135 for receiving laser beam 125 reflected in field of view 120. Reflected laser beam 125 passes the same mirror facet 119 of polygon mirror 117 and is deflected thereby via a receiving path 130 to receiver 135. Receiver 135 may, for example, include at least one receiver module, which includes one or multiple detectors, for example, photodetectors, photodiodes and/or cameras and also receiving optics that include further optical components. This is not represented, however, for reasons of clarity. In addition, both emission path 110 as well as receiving path 130 may include further emission optics or receiving optics, which are not represented in FIG. 1.

Polygon mirror 117 is situated, in particular, between emitter 105 and receiver 135—emitter 105, for example, to the left of polygon mirror 117 and receiver 135 to the right of polygon mirror 117 and in this way separates emission path 110 spatially or locally from receiving path 130. Since the emitted light or emitted laser beam 115 may cause parasitic losses and reflections at the passage at the front pane of device 100 or in the emission optics, which have a disruptive effect on receiver 135, the spatial or local separation of emission path and receiving path 110, 130 is particularly advantageous. As a result of the local separation of the optical paths or ways or beam paths, emitted laser beam 115 is no longer able to directly enter receiving path 130 and, based on the separation of the paths, the quality of the received signal may therefore be improved.

With the aforementioned explanation of laser beam 115 emitted via polygon mirror 117 into field of view 120 and laser beam 125 reflected from the field of view via the same mirror facet 119, it should also be noted in each case that emitted laser beam 115 and reflected laser beam 125 are located in the same plane. Emitted radiation and received radiation are thus situated in the same plane or emitted beam and received beam are each situated at the same height.

Given the fact that emitted radiation and received radiation are situated in the same plane, and thus a lower rotating mirror height for the beams is required, LIDAR device 100 is particularly advantageously suitable for use at or in a vehicle. For example, provided LIDAR device 100 may be advantageously inserted in the vehicle roof or at the radiator grill of a vehicle due to the overall compact shape of device 100, since as a rule only very little space is available at the aforementioned locations. Provided device 100 thus enables a virtually concealed integration at/in the vehicle.

FIG. 2 schematically shows a representation of a LIDAR device 200 according to a second specific embodiment. LIDAR device 200 in FIG. 2 is designed similarly to LIDAR device 100 in FIG. 1, therefore only the essential differences are explained in greater detail below. For the remaining features, reference is made to the above explanation. In contrast to FIG. 1, in which emitter 105 and receiver 135 are situated essentially in the transverse direction, i.e., horizontally or schematically in parallel to the x-axis, emitter 205 and receiver 235 in FIG. 2 are situated essentially in the longitudinal direction, i.e. vertically or schematically in parallel to the y-axis.

Alternatively, it is possible to arrange only emitter 105 or only receiver 235, respectively, essentially in the longitudinal direction, i.e., in parallel to the y-axis. For the sake of clarity, however, this is not shown in FIG. 2.

A first deflection mirror 211 is situated in emission path 210 between emitter 205 and polygon mirror 117. First deflection mirror 211 enables an essentially right-angled deflection of laser beam 215 emitted by emitter 205 on emission path 210 onto the at least one mirror surface 119 of polygon mirror 117. Since receiver 235 in FIG. 2 is also situated essentially in the longitudinal direction, LIDAR device 200 includes a second deflection mirror 231 in receiving path 230 between polygon mirror 117 and receiver 235. Second deflection mirror 231 is designed to enable an essentially right-angled deflection of laser beam 239 reflected from field of view 120 onto polygon mirror 117 on receiving path 230 onto receiver 235. LIDAR device 200 advantageously enables a narrow design in the transverse direction, i.e., horizontally or schematically in parallel to the x-axis, because emitter 205 and receiver 235 are shifted via the two deflection mirrors 211, 231 rearward, i.e. in the longitudinal direction or schematically in parallel to the y-axis which, for example, may describe the depth plane for device 200, so that the length or depth (or the schematic extension in parallel to the y-axis) of LIDAR device 200 is thereby increased.

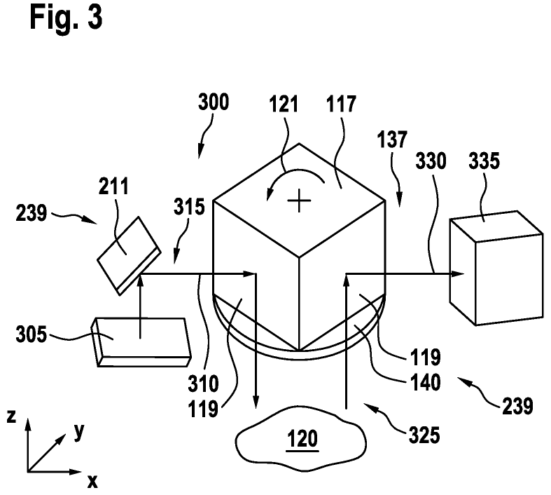

FIG. 3 schematically shows a representation of a LIDAR device 300 according to a third specific embodiment. In contrast to LIDAR devices 100, 200 in FIGS. 1 and 2, emitter 305 has a planar design, i.e., with preferably little height extension or schematic extension along the z-axis in FIG. 3, and is integratable into a bottom plate of LIDAR device 200. For the sake of clarity, however, the bottom plate of LIDAR device 300 is not shown. Alternatively or in addition, receiver 335 may also have a planar design, i.e., also with preferably little height extension or schematic extension in the z-direction.

Planar receiver 335 may also be integrated into the bottom plate of LIDAR device 300 in order to enable overall a LIDAR device 100 with preferably little extension in the z-direction and to thereby advantageously reduce the height of polygon mirror 117. This, too, is not represented in FIG. 3 for reasons of clarity.

In combination with first deflection mirror 211, laser beam 315 emitted by emitter 305 is deflected on emission path 310 to mirror surface 119 of polygon mirror 117, emission path 310 and receiving path 330 and thus emitted laser beam 315 and reflected, i.e., laser beam 325 to be received, being situated essentially in the same plane, i.e., at approximately the same height, and strike the same mirror surface 119 of polygon mirror 117 essentially in the same plane. Rotation drive unit 140 in FIG. 3 is mounted, for example, in the bottom area of polygon mirror 117. Receiving path 330 in FIG. 3 includes, for example, no deflection mirror. If, like receiver 305, receiver 335 as cited above also had a planar or flat design, then receiving path 330 could also include a further deflection mirror similar to the arrangement in emission path 310 in order to deflect reflected laser radiation 325 at an essentially right angle to receiver 335.

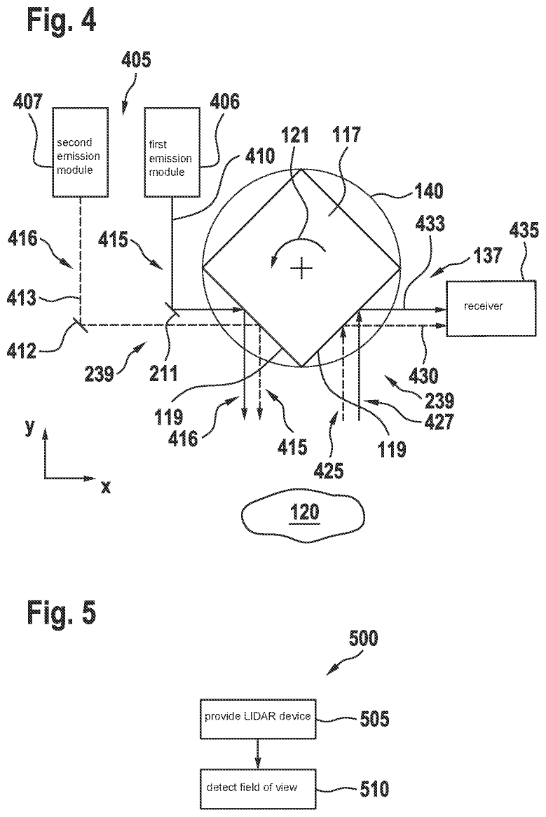

FIG. 4 schematically shows a representation of LIDAR device 400 according to a fourth specific embodiment. In contrast to devices 100, 200, 300 in FIGS. 1 through 3, device 400 includes, for example, an emitter 405 including a first emission module 406 and a second emission module 407, which are marked in a following Table 1, for example, as “2 emitters,” first emission module 406 and second emission module 407 being situated, for example, spatially/locally separated from one another. For example, first emission module 406 is situated essentially in the longitudinal direction, i.e., schematically in parallel to the y-axis, and emits laser radiation 415 into field of view 120 on first emission path 410 via first deflection mirror 211 and mirror surface 119 of polygon mirror 117. The beam path is schematically shown in FIG. 4 by the dashed line. Second emission module 407 is also situated, for example, essentially in the longitudinal direction, i.e., schematically in parallel to the y-axis. The two emission modules 406, 507 being drawn next to one another is solely for the purpose of clearer representation and the two emission modules 406, 407 may, of course, also be shown one behind the other in the longitudinal direction in parallel to the y-axis. For example, second emission module 407 may then be situated below first emission module 406 or vice versa, so that first emission module 406 and second emission module 407 are situated opposite one another along the y-axis (not shown). Second emission module 407 emits, for example, via a second emission path 413, a laser beam 416, which is deflected via a fourth deflection mirror 412 essentially at a right angle onto mirror surface 119 of polygon mirror 117. The beam path of laser radiation 416 of second emission module 407 is schematically represented as a continuous line in FIG. 4.

The two emitted laser beams 415, 416 are finally reflected 425, 427 in field of view 120 (same schematic notation with dashed line as reflected laser beam 425 of laser beam 415 emitted via first emission path 410 and continuous line as reflected laser beam 427 of emitted laser beam 416 emitted via second emission path 413) and, due to rotation 121 of polygon mirror 117, arrive via the same mirror surface 119 at essentially a right angle at receiver 435. Reflected laser beam 425 arrives, for example, via first receiving path 430 at receiver 435 and further reflected laser beam 427 arrives, for example, via second receiving path 433 at receiver 435. The two emitted laser beams 415, 416 as well as the two reflected laser beams 425, 427 may strike the same mirror surface 119 in each case in the same plane, i.e., at the same height or beam height.

The slight offset of the two emitted laser beams 415, 416 and of the two reflected laser beams 425, 427 is delineated in FIG. 4 for the purpose of better clarity. The beam paths may, however, also be approximately situated without an offset.

Instead of the arrangement of first emission module 406 and of second emission module 407 of emitter 405 in each case essentially in the longitudinal direction, i.e., schematically in parallel to the y-axis, first emission module 406 and second emission module 407 may also each have a planar design, similar to emitter 305 in FIG. 3. First emission module 406 may emit laser radiation 415 into field of view 120 on first emission path 410 via first deflection mirror 211 and via mirror surface 119 of polygon mirror 117. Second emission module 407 may emit a laser beam 416 via second emission path 413, which is deflected via fourth deflection mirror 412 at essentially a right angle onto mirror surface 119 of polygon mirror 117. This is marked in Table 1 as an alternative to FIG. 4, the two emission modules 406 and 407 being marked in Table 1 as “2 emitters.”

It is further possible that, for example, first emission module 406 has a planar design, and laser radiation 415 is emitted into field of view 120 on first emission path 410 via first deflection mirror 211 and via mirror surface 119 of polygon mirror 117. Second emission module 407 may, for example, be situated essentially in the longitudinal direction, i.e., schematically in parallel to the y-axis and may emit a laser beam 416, for example, via second emission path 413, which is deflected via a fourth deflection mirror 412 at essentially a right angle onto mirror surface 119 of polygon mirror 117. This variant is not listed in Table 1, however.

A control unit, which is communicatively connected to the emitter, receiver and rotation drive unit, is not represented in the figures. At this point, it is noted that LIDAR devices 100, 200, 300, 400 each may include such a control unit. For reasons of clarity, the one-sided and two-sided mounting of polygon mirror 117 is also not represented in FIGS. 1 through 4. Polygon mirror 117 may, however, include such a mounting not represented.

The exemplary embodiments explained above may be summarized with their variants or alternatives in tabular form as follows:

TABLE 1

| | | | | | Receiver | Emitter | |
|---|---|---|---|---|---|---|---|
| | Deflection | Deflection | | | in | in | |
| | mirror | mirror | | | longi- | longi- | Additional |
| | emission | receiving | Receiver | Emitter | tudinal | tudinal | deflection |
| | path | path | planar | planar | direction | direction | mirror |
| FIG. 2 | x | x | | | x | x | |
| Alternative | x | | | | | x | |
| to | | | | | | | |
| FIG. 2 | | | | | | | |
| Alternative | | x | | | x | | |
| to | | | | | | | |
| FIG. 2 | | | | | | | |
| FIG. 3 | x | | | x | | | |
| Alternative | | x | x | | | | |
| to | | | | | | | |
| FIG. 3 | | | | | | | |
| Alternative | x | x | x | x | | | |
| to | | | | | | | |
| FIG. 3 | | | | | | | |
| FIG. 4 | x | | | | | x (2 | x |
| | | | | | | emitters) | |
| Alternative | x | | | x (2 | | | x |
| to | | | | (emitters) | | | |
| FIG. 4 | | | | | | | |

FIG. 5 schematically shows a representation of a method 500 for optically detecting a field of view, for example, field of view 120 in FIGS. 1 through 4, for a vehicle. In a first step 505 of the method 500, a LIDAR device 100, 200, 300, 400 including the features and components explained above is provided and in a second step 510, field of view 120 is detected with the aid of provided LIDAR device 100, 300, 300, 400. In addition, the detected data of field of view 120 may also be evaluated, which is not represented in FIG. 5 and which may be carried out, for example, by a control unit and/or a computer.

The present invention has been described in detail using preferred exemplary embodiments. Instead of the exemplary embodiments described, further exemplary embodiments are possible, which may include further modifications or combinations of described features. For this reason, the present invention is not limited by the described examples, since other variations thereof may be derived by those skilled in the art without departing from the scope of protection of the present invention in the process.

1-10. (canceled)

11. A LIDAR device for a vehicle, comprising:
an emitter configured to emit at least one laser beam on an emission path;
a receiver configured to receive at least one reflected laser beam on a receiving path; and
a rotating mirror configured to deflect the laser beam via the emission path into the field of view and for deflecting the laser beam reflected in the field of view onto the receiving path, the rotating mirror being situated between the emitter and the receiver and separating the emission path from the receiving path, the rotating mirror being a polygon mirror and including at least one mirror surface for deflecting the laser beam via the emission path into the field of view and for deflecting the laser beam reflected in the field of view onto the receiving path, the laser beam emitted via the emission path into the field of view and the laser beam reflected from the field of view striking the same at least one mirror surface of the polygon mirror in the same plane.

12. The LIDAR device as recited in claim 11, further comprising:
a first deflection mirror situated in the emission path between the emitter and the polygon mirror, the first deflection mirror enabling a right-angled deflection of the laser beam emitted by the emitter on the emission path onto the at least one mirror surface of the polygon mirror, and/or
a second deflection mirror situated in the receiving path between the polygon mirror and the receiver, the second deflection mirror enabling a right-angled deflection of the laser beam reflected by the field of vision onto the polygon mirror on the receiving path to the receiver.

13. The LIDAR device as recited in claim 12, wherein the emitter has a planar configuration and is integratable into a bottom plate of the LIDAR device, and/or the receiver has a planar configuration and is integratable into a bottom plate of the LIDAR device.

14. The LIDAR device as recited in claim 12, wherein the emitter is situated in a longitudinal direction and/or the receiver is situated in the longitudinal direction.

15. The LIDAR device as recited in claim 12, wherein the emitter includes a first emission module and a second emission module for emitting multiple laser beams into the field of view, the first deflection mirror being situated in a first emission path between the first emission module and the polygon mirror, which enables a right-angled deflection of the laser beam emitted by the first emission module on the first emission path onto the at least one mirror surface of the polygon mirror, wherein a third deflection mirror is situated in a second emission path between the second emission module and the polygon mirror, which enables an right-angled deflection of the laser beam emitted by the second emission module on the second emission path onto the at least one mirror surface of the polygon mirror, the laser beam emitted on the first emission path and/or the laser beam emitted on the second emission path and/or the laser beams reflected in the field of view striking the same at least one mirror surface of the polygon mirror in the same plane.

16. The LIDAR device as recited in claim 11, wherein the laser beam emitted via the polygon mirror into the field of view causes a point illumination and/or a line illumination of the field of view.

17. The LIDAR device as recited in claim 11, wherein the polygon mirror includes four mirror surfaces.

18. The LIDAR device as recited in claim 11, wherein the polygon mirror includes a rotation drive unit for moving the polygon mirror.

19. The LIDAR device as recited in claim 11, wherein the polygon mirror is mounted on one side or on two sides.

20. A method for optically detecting a field of view for a vehicle, the method comprising the following steps:
a) providing a LIDAR device including:
an emitter configured to emit at least one laser beam on an emission path,
a receiver configured to receive at least one reflected laser beam on a receiving path, and
a rotating mirror configured to deflect the laser beam via the emission path into the field of view and for deflecting the laser beam reflected in the field of view onto the receiving path, the rotating mirror being situated between the emitter and the receiver and separating the emission path from the receiving path, the rotating mirror being a polygon mirror and including at least one mirror surface for deflecting the laser beam via the emission path into the field of view and for deflecting the laser beam reflected in the field of view onto the receiving path, the laser beam emitted via the emission path into the field of view and the laser beam reflected from the field of view striking the same at least one mirror surface of the polygon mirror in the same plane; and
b) detecting the field of view using the LIDAR device.
